(19) United States
(12) Patent Application Publication
(10) Pub. No.: US 2007/0239413 A1
(43) Pub. Date: Oct. 11, 2007

(54) Local/local and mixed local/global interpolations with switch logic

(76) Inventor: Jiun-Der Yu, Sunnyvale, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/398,775

(22) Filed: Apr. 6, 2006

(51) Int. Cl. G06G 7/48

(52) U.S. Cl. 703/9

(57) ABSTRACT

System and methods for simulating fluid flow through a channel and exiting the channel. The fluid flow includes an interface between a first fluid and a second fluid. Create a mesh representative of a physical space of the channel and a portion of a physical space around the channel. Create a level set representative of the interface. A set of equations is solved which describes aspects of the first fluid, the second fluid and the interface. Particular values in the level set are re-distanced using two or more of the following re-distancing methods: a bicubic interpolation method, a global interpolation method, or a local linear interpolation method. Switching between the re-distancing methods for each particular value is based upon one or more switching rules.

### RELATED APPLICATIONS

This application is related to: U.S. patent application Ser. No. 10/390,239 filed on Mar. 14, 2003 and entitled “Coupled Quadrilateral Grid Level Set Scheme for Piezoelectric Ink-Jet Simulation;” and U.S. patent application Ser. No. 10/729,637 filed on Dec. 5, 2003 and entitled “Selectively Reduced Bi-Cubic Interpolation for Ink-Jet Simulations on Quadrilateral Grids;” and U.S. patent application No. 10/957,349 filed on Oct. 1, 2004, entitled “2D Central Difference Level Set Projection Method for Ink-Jet Simulations” which are all incorporated herein by reference.

### BACKGROUND OF THE INVENTION

1. Field of the Invention

The present invention relates to systems and methods for modeling, simulating and analyzing ink ejection from a print head. More particularly, an embodiment of the invention includes a quadrilateral mesh for a finite-difference-based ink-jet simulation where an algorithm is designed to solve a set of partial differential equations for two-phase flows on the quadrilateral mesh. The simulation model may be embodied in software, hardware or a combination thereof and may be implemented on a computer or other processor-controlled device.

2. Description of the Related Art

An ink-jet print head is a printing device which produces images by ejecting ink droplets onto a print medium. Control of the ink ejection process and the ensuing ink droplet is essential to ensuring the quality of any product created by the print head. To achieve such control it is important to have accurate and efficient simulations of the printing and ejection process. Simulating this process includes modeling of at least two fluids (i.e., ink and air) and the interface between these fluids. Prior art methods have used computational fluid dynamics, finite element analysis, finite difference analysis, and level set methods to model this behavior.

The level set method is an effective technique for capturing an interface (e.g., the interface between ink and air in a print head nozzle). In order to maintain accuracy and stability of a simulation using the level set method, the simulation should be stopped periodically and the level set re-distanced. Prior art methods have used bicubic interpolation methods, reduced bicubic interpolation methods and triangulated fast marching methods to re-distance the level set. Prior art methods have had difficulty with re-distancing when the interface includes a sharp corner.

### OBJECT AND SUMMARY OF THE INVENTION

### Object of the Invention

It is an object of the present invention to provide a method for simulating and analyzing ink ejection that overcomes the above problems. Thus, enabling more precise control of ink droplet size and shape.

### Summary of the Invention

The invention is a system or method for simulating fluid flow through a channel and exiting the channel. The fluid flow includes an interface between a first fluid and a second fluid. A mesh is created representative of a physical space of the channel and a portion of a physical space around the channel. A level set is created including a group of values. Each value is associated with a point in the mesh. Each value in the group of values is proportional to the shortest distance from the associated point to the interface. A set of equations is solved which describes aspects of the first fluid, the second fluid and the interface. Particular values in the level set are re-distanced using two or more of the following re-distancing methods: a bicubic interpolation method; a global interpolation method; and a local linear interpolation method. Switching between the re-distancing methods for each particular value is based upon one or more switching rules. Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts:

FIG. 1 illustrates a typical ink jet head nozzle;

FIG. 2 illustrates a boundary-fitted quadrilateral mesh that might be used in an ink-jet simulation;

FIG. 3 is a sequence of simulation results illustrating the ejection of an ink droplet;

FIG. 4 is an illustration of an artifact created by the simulation;

FIGS. 5A and 5B are illustrations of relative points at which variables might be calculated on a uniform mesh;

FIG. 6 is an illustration of a flowchart of a numerical algorithm in which an embodiment of the invention may be implemented;

FIG. 7 is an illustration of a portion of a uniform mesh showing cells used in accordance with bicubic interpolation;

FIGS. 8A-8E are illustrations of portions of an offset quadrilateral mesh including portions of an interface in which examples of local interpolation are shown;

FIG. 9 is an illustration of a portion of an offset quadrilateral gird;

FIG. 10 is an illustration of a flowchart of a method of performing local linear interpolation;

FIG. 11 is an illustration of a flowchart of a method of re-distancing a level set value using the results of a contour plotting algorithm;

FIG. 12 is an illustration of a portion of an offset quadrilateral mesh including a portion of an interface in which an example of re-distancing given the results of a contour plotting algorithm might be used;

FIG. 13 is an illustration of a portion of a quadrilateral mesh showing: segments 1-7 which approximate a portion of an interface; angles between segments and previous segments and results of cross products which are representative of the direction a segment is heading relative to a previous segment; and

FIG. 14 is a block diagram illustrating an exemplary system which may be used to implement aspects of the present invention.

### DESCRIPTION OF THE PREFERRED EMBODIMENTS

I. Introduction

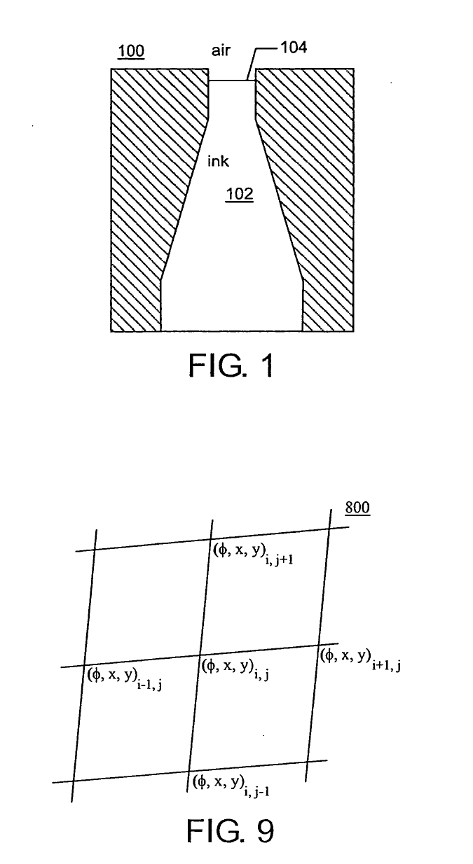

FIG. 1 shows a typical ink jet print head nozzle 100 including ink 102 and an interface 104 between the ink 102 and the air. A pressure pulse is applied to the ink 102 causing an ink droplet to be formed at the interface 104. The pressure pulse may be produced by applying a dynamic voltage to a piezoelectric (PZT) actuator which is coupled to the ink 102 via a pressure plate.

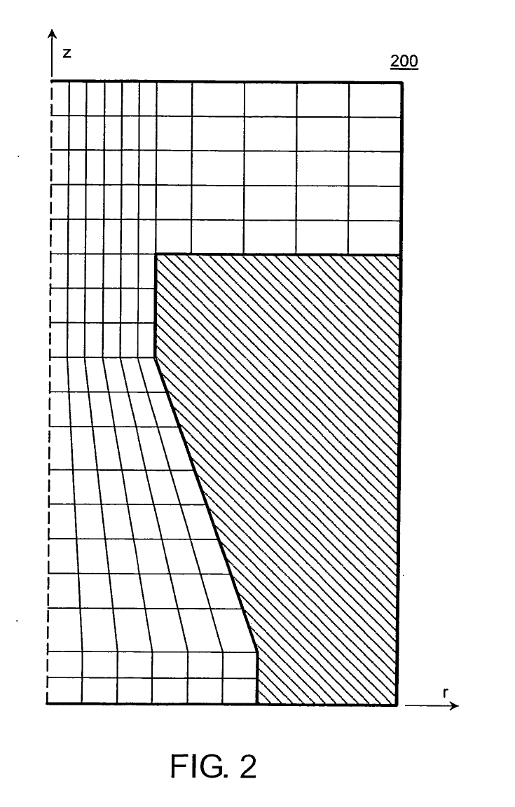

When designing the print head nozzle 100 it is useful to simulate the production of ink droplets using computational fluid dynamics (CFD) code. The CFD code simulates production of ink droplets by solving a set of governing partial differential equations, (i.e., the incompressible Navier-Stokes equations for two-phase flows), for fluid velocity, pressure and interface position. The Navier-Stokes equations are exemplarily, other equations which describe the behavior of the ink droplets may also be used without changing the scope of the claimed invention. FIG. 2 is an example of a body-fitted quadrilateral mesh 200 that the CFD code in an embodiment of the invention may use to represent the physical space in which the ink droplets are produced.

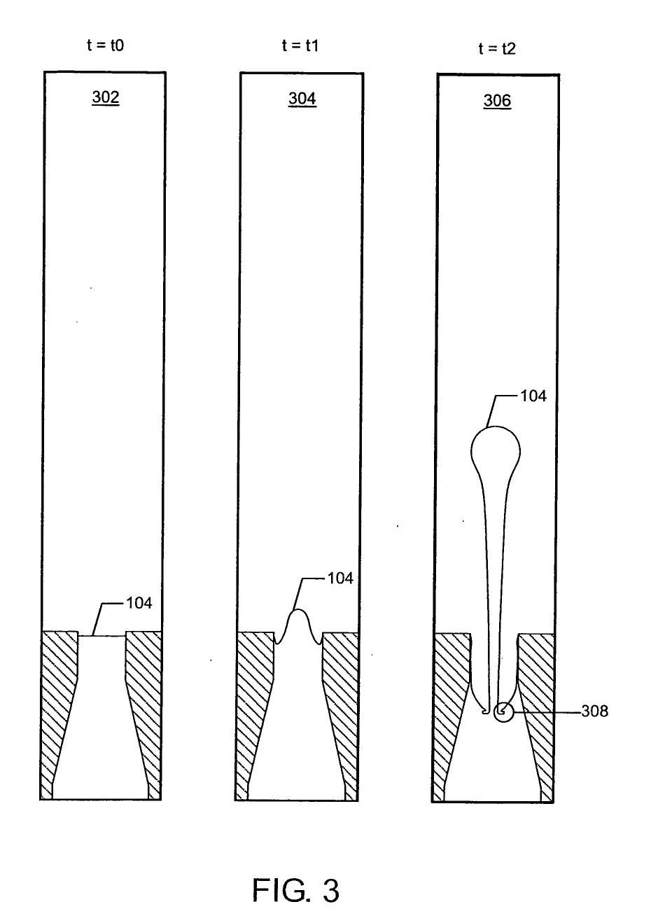

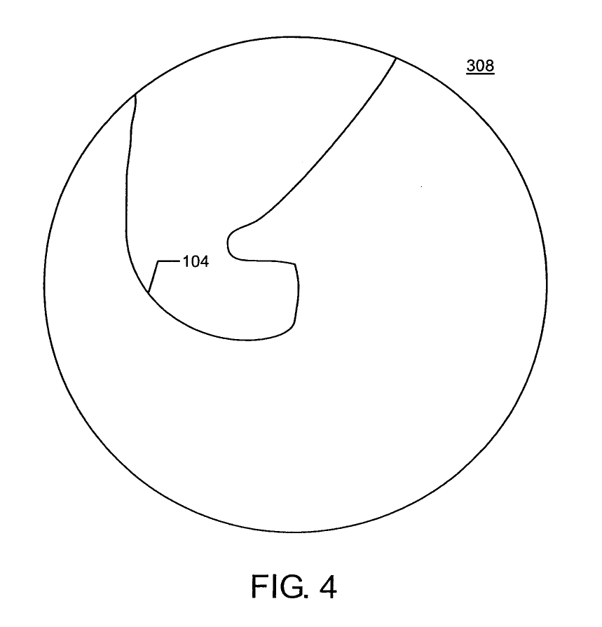

FIG. 3 is a series of snapshots representative of the results of the CFD code. A snapshot 302 at a time t0 is representative of an initial state of the print head nozzle 100. A snapshot 304 at a time t1 is representative of the print head nozzle 100 as it begins to produce a droplet. A snapshot 306 is representative of the print head nozzle 100 at a latter time t2 as the droplet is being produced. The snapshot 306 includes an artifact 308. The artifact 308 is not representative of the behavior of ink 102, but is instead an artifact produced by the CFD code. FIG. 4 is a magnified view of the artifact 308. An object of the present invention is to reduce the size or eliminate the appearance of artifacts of this type.

The interface 104 is represented by a zero level set F of a level set function φ. The level set function φ is initialized as a signed distance to the interface 104, i.e., the level set value is the shortest distance to the interface on the ink 102 side and is the negative of the shortest distance on the air side. The level set function φ is calculated at each node in the mesh 200.

II. Governing Equations

Governing equations for two-phase flow include the continuity equation, the Navier-Stokes equations, and the level set convection equation (1), which are set forth in the Appendix along with the other numbered equations referenced in the following discussion. In these equations, u is a velocity vector, t is time, ρ is the relative density, p is the pressure, μ is the relative dynamic viscosity, Re is the Reynolds number, We is the Weber number, Fr is the Froude number, κ is the curvature, δ is the Dirac delta function and [symbol] is the rate of deformation tensor. The relative density ρ, the relative dynamic viscosity μ, and the curvature κ are all defined in terms of the level set function φ.

The typical print head nozzle 100 is rotationally symmetric. Therefore, it is advantageous to model the print head nozzle 100 in a cylindrical coordinate system. It is reasonable to assume that the results will be independent of the azimuth. Therefore, the model can be reduced from three dimensions to an axisymmetric physical space, X=(r, z). The body-fitted quadrilateral mesh 200 is created in this physical space, X. This physical space can be transformed via a transformation Φ which maps nodes in the physical space X to a computational space Ξ=(ξ, η). Finite difference analysis may be used to solve the governing equations on the mesh 200 in this computational space Ξ. The Jacobian [symbol] (2) and the transformation matrix [symbol] (3) of this transformation can be found in the Appendix. For axisymmetric coordinate systems g=2πr. Evaluating the continuity equation, the Navier-Stokes equations, and the level set convection equation (1) in the computational space Ξ involves transforming equations (1) into equations (4) with the help of the Jacobian (2) and the transformation matrix (3). The viscosity term on the right hand side of the Navier-Stokes equations (4) is given by equation (5), when evaluated in the computational space Ξ.

III. Numerical Algorithm:

A numerical algorithm is formulated on the quadrilateral mesh. In the following, the superscript n (or n+1) denotes the time step. Given quantities uⁿ, pⁿ, and φⁿ the purpose of the algorithm is to obtain uⁿ⁺¹, pⁿ⁺¹, and φⁿ⁺¹ which satisfy the governing equations. An embodiment of the invention may include an algorithm which is first-order accurate in time and second-order accurate in space. The invention is not limited to including algorithms of this accuracy but may include other formulations.

A. Smearing of the Interface

In a typical system the densities and the viscosities of both fluids are very different. The abrupt change in density and viscosity across the interface 104 may cause difficulties in simulation. Therefore, this abrupt change may be replaced by a smoothed function. The smoothing may occur in a region of space with a thickness of 2ε centered around the interface 104. Thus ε is representative of the extent of smearing of the interface 104. An example of such a smoothed function are a smoothed Heavyside function and a smoothed Dirac delta function shown in equation (6). The relative density with abrupt change across the interface 104 is hence smoothed to be (7), where ρ₂/ρ₁ is the density ratio of the second fluid (air) to the first fluid (ink). A typical value for ε may be proportional 1.7 to 2.5 times the average size of a quadrilateral cell in mesh 200.

B. Level Set, Velocity Field and Pressure Field Update

The level set function φⁿ⁺¹ may be calculated using equation (8). The time-centered advection term in equation (8) may be evaluated using an explicit predictor-corrector scheme that only requires data available at time tⁿ.

An intermediary value u^{★} may be calculated using equation (9) which may be derived from equation (4). After which a pressure field pⁿ⁺¹ may be calculated using equation (10). A new velocity vector field uⁿ⁺¹ may be calculated using equation (11).

C. Re-Initialization of the Level Set

To correctly capture the interface 104 and accurately calculate the surface tension, the level set needs to be maintained as a signed distance function to the interface 104. However, if the level set is updated by equation (8), it will not remain as such. Therefore, instead, the simulation is periodically stopped and a new level set function φ is recreated. A more detailed description of this re-initialization will be given later.

D. Spatial Discretization

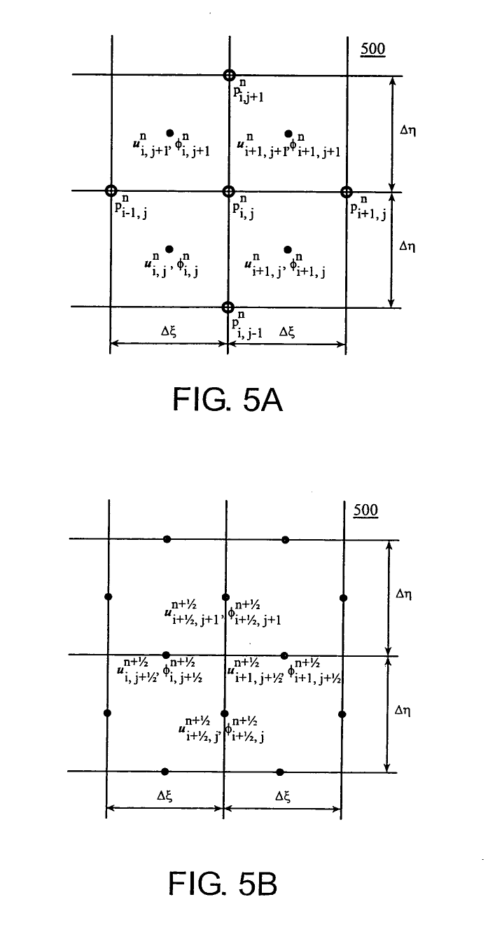

As seen in FIGS. 5A and 5B the transformation X=Φ(Ξ) is such that a computational mesh 500 in the computational space is composed of unit squares, Δξ=Δη=1. The boundary-fitted quadrilateral mesh in FIG. 2 is mapped to the uniform computational mesh 500 with unit squares.

Throughout the following discussion variables are calculated on nodes of one or more girds. The relative position of nodes is represented by pairs of variables either in parentheses or as subscripts (Z(x,y)⇄Z_{x,y}) FIGS. 5A and 5B illustrate a portion of the uniform computational mesh 500. As shown in FIG. 5A at integer time steps the velocity components uⁿ(i,j) and the level set φⁿ(i,j) values are calculated at the centers of each cell in the uniform computational mesh. Also shown in FIG. 5A at integer time steps the pressure pⁿ(i,j) is calculated at nodes of the uniform computational gird. FIG. 5B shows time-centered edge velocities u ^{n+1/2}(i+½,j) and level set predictors φ^{n+1/2}(i+½,j) calculated at half time steps at the middle point of each edge.

Note that only the local definition of the transformation (or mapping) is needed in the algorithm. The existence or the exact form of the global transformation X=Φ(Ξ) is not important.

E. The Advection Term

An algorithm for advection terms may be based on an un-split second-order Godunov method described by John B. BELL et al., in “A Second-order Projection Method for Variable-Density Flows,” Journal of Computational Physics, 101, pp. 334-348, 1992, for two-phase (two constant densities) flows. It is a cell-centered predictor-corrector scheme.

To evaluate the advection terms, equations (12) and (13) are used. In these equations the edge velocities and edge level sets are obtained by a Taylor's expansion in space and time. The time derivative of the velocity is substituted by the Navier-Stokes equations. The time derivative of the level set is substituted with the level set convection equation. Extrapolation is done from both sides of the edge and then Godunov type upwinding is used to choose which extrapolation result to use.

The term u^{n+1/2}(i+½,j) is calculated using the following method. Extrapolating from the left, yields equation (14) where Fⁿ(i,j) is given in equation (15). Extrapolating from the right yields equation (16). The next step is the Godunov upwinding. The advective velocities are decided by equations (17) and (18). Other time-centered edge values may be calculated in a similar manner.

F. The Flowchart

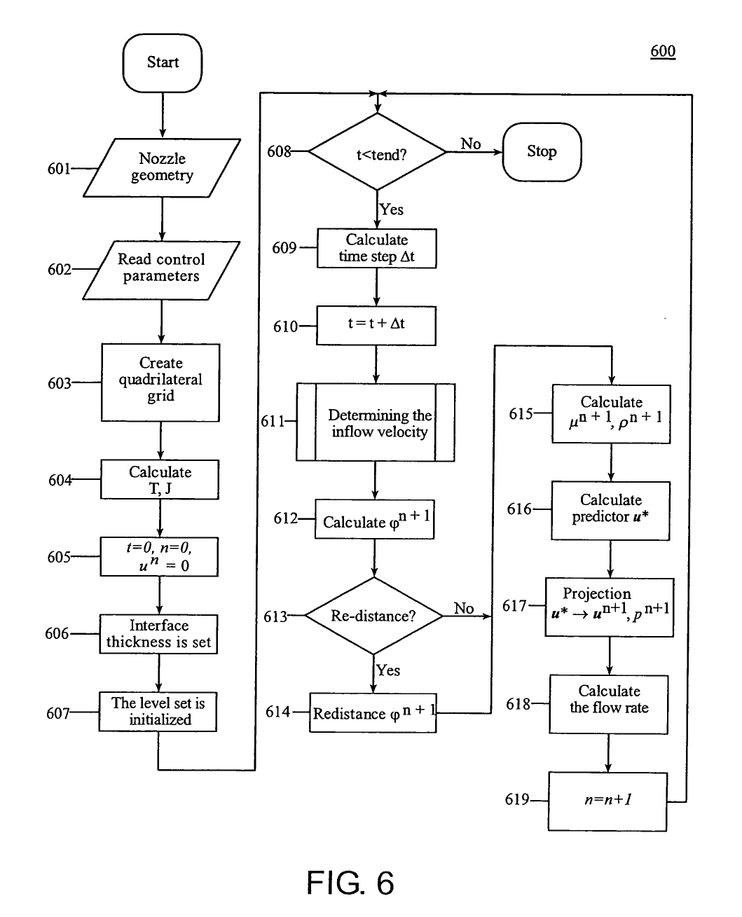

An embodiment of the present invention may be implemented as part of a numerical algorithm exemplified by a flowchart 600 such as in FIG. 6. In a step 601 the nozzle geometry is read. Then, in a step 602 the control parameters are read. Exemplary control parameters are: end time of the simulation; extent of interface smearing and how often the level set should be re-initialized. Given the nozzle geometry, the body-fitted quadrilateral mesh 200 such as in FIG. 2 is created in a step 603. In a step 604 the transformation matrix T and the Jacobian [symbol] are calculated. The time, the number of the current time step and the initial fluid velocity are set to zero in a step 605. Given a smearing parameter, the interface thickness is set in a step 606. The initial ink to air interface 104 may be assumed to be flat and the level set is initialized accordingly in a step 607.

In a step 608 a loop is started by checking whether the time t is less than the amount of time, tend, in which the loop is designed to run. If so, in a step 609 a time step Δt is calculated which ensures stability of the code. Otherwise the simulation is stopped. In a step 610 the time is updated. In a step 611 the time step and the ink flow rate are used to determine the inflow velocity of the ink. Once the inflow velocity is determined the CFD code is used to solve the partial differential equations which govern the behavior of the ink. In a step 612 the level set calculated. During a step 613 it is determined whether or not to re-distance the level set in a step 614. The level set may be re-distanced after a specific number of time steps or other criteria might be used. During a step 615 the viscosity and the density are calculated using the level set values. In a step 616 a velocity predictor may be calculated. In a step 617 the velocity predictor may be projected into a divergence-free space to get new pressure and incompressible velocity fields. In a step 618 a new ink flow rate is calculated. In a step 619 the time step is incremented and the loop returns to step 608.

IV. Re-distancing of the Level Set As noted earlier problems of this type when solved using methods described in the prior art produce artifacts of the type shown in FIG. 4. To address this problem the inventors have developed the following methods of re-distancing the level set. These methods may be performed during the step 614. These methods may also be performed during the operation of other algorithms well known in the art.

An embodiment of the present invention may include: a local interpolation method; a global interpolation method; and switching logic which guides the choice between the two methods. The global interpolation method may be implemented as a two-dimensional contour plotting algorithm with an exact distance calculation. The local interpolation method may be a bicubic interpolation method. At each node within one cell from the interface, two new level set values may be calculated using the bicubic interpolation method or the contour plotting method. The switching logic is used to choose between these two methods. The switching logic may use the results of contour plotting method when choosing between the two methods.

An alternative embodiment of the present invention may include a bicubic interpolation method, a local linear interpolation and switching logic which guides the choice between the two methods. A further alternative may include the use of the triangulated fast marching method. The triangulated fast marching method may be used for cells that are not near the interface 104 or are more than one cell away from the interface 104. Alternatively cells that are not near the interface 104 are not re-distanced.

A. Bicubic Interpolation

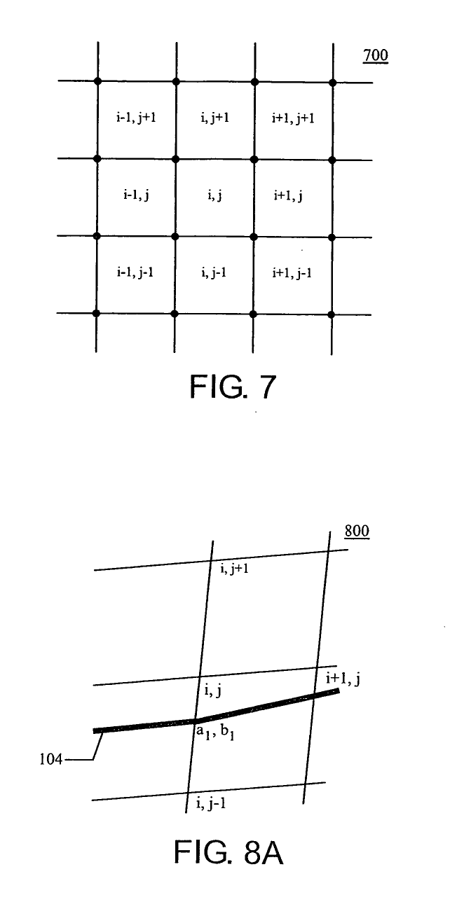

FIG. 7 is an offset computational mesh 700. The nodal points of the mesh 700 coincide with the locations of φⁿ(i,j) as shown in FIG. 5A. Referring to FIG. 7, for a central cell i,j a local interpolation function f(r,z) is constructed and used to re-distance the level set. An example of such a local interpolation function is the bicubic interpolation function described in U.S. patent application 10/957,349 filed on Oct. 1, 2004 by the same inventor of the present application and is hereby incorporated by reference. The level set value is calculated at the nodes of the central cell i,j, using information from the cell i,j and it's 8 nearest neighboring cells. It may not be useful to use bicubic interpolation for some nodes. For example, if the some of the nearest neighbors are missing, such as a cell i,j next to a simulation boundary. Bicubic interpolation as used in this application should be taken to mean the bicubic interpolation method or a reduced bicubic interpolation method.

B. Local Linear Interpolation

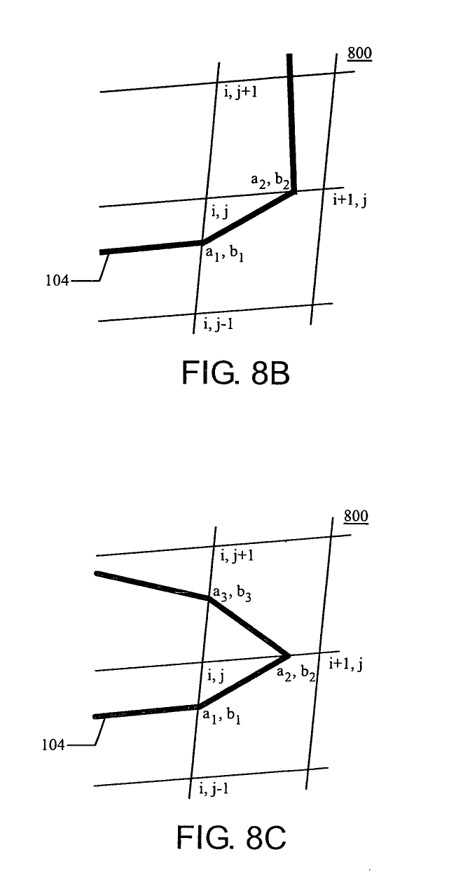

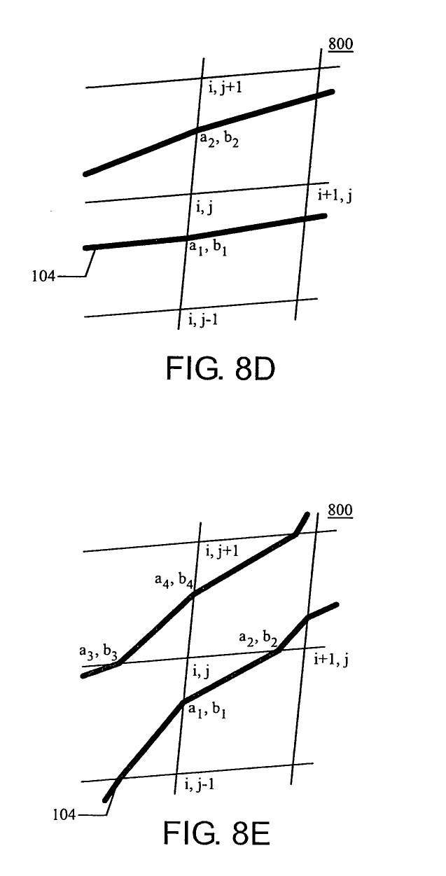

Local linear interpolation may also be used when bicubic interpolation is inappropriate. FIG. 8A, shows an offset quadrilateral mesh 800. As with the mesh 700, the quadrilateral mesh 800 is offset from the mesh 200 as nodal points of the mesh 800 are centered on points at which the level set φ is calculated. FIG. 8A also illustrates points in which local interpolation may be used. FIG. 8A illustrates an example in which only one of four neighboring nodes for node i,j is on the other side of the interface 104. Here the new level set value φ(i,j) at node i,j may be taken as a signed distance s from nodal point x(i,j), y(i,j) to a point a₁, b₁ that the interface 104 crosses the mesh line of mesh 800, the distance s may be calculated using φ(i,j) and φ(i,j-1), as shown in equations (19) through (21). Alternatively a new level set value φ(i,j) may be found by calculating the shortest distance from the node to the interface 104. The calculations described above were described in the context of a quadrilateral mesh. As is well known in the art these calculations may also be performed on a uniform mesh.

FIG. 8B is an illustration of a node i,j at which two of the four neighboring nodes are on the other side of the interface 104. The coordinates of the points where the interface crosses the mesh lines at the right hand side are a₂, b₂ and at the lower side are a₁, b₁. These coordinates are obtained by linearly interpolating the old level set values φ(i,j), φ(i+1,j) and φ(i,j−1), in a similar manner to the equations (19) and (20). The coordinates of the closest point from the segment connecting a₁, b₁, and a₂, b₂, to the node i,j can be represented in parametric format as shown in equation (22). A new value for φ(i,j) may be calculated using equations (23)-(25).

FIG. 8C is an illustration of node i,j at which three of the neighboring nodes are on the other side of the interface 104. As described above coordinates of points where the interface 104 crosses the mesh lines at the right, lower, upper sides, a₁, b₁, a₂, b₂ and a₃, b₃, can be easily obtained by linearly interpolating old level set values φ(i,j), φ(i+1,j), φ(i,j+1) and φ(i,j−1). The closest point may be on the line connecting a₁, b₁ and a₂, b₂ or on the line connecting a₃, b₃ and a₂, b₂. Hence we repeat the procedure proposed for FIG. 8B and choose the smaller of the possible new level set values. Exemplary equations for solving for a new level set value in this circumstance are given in equations (26)-(30).

FIG. 8D is an illustration of the node i,j at which two opposite neighboring nodes are on the other side of the interface 104. The new φ(i,j) may be the shorter of a distance from x(i,j), y(i,j) to a₁, b₁ or a distance from x(i,j), y(i,j) to a₂, b₂. Alternatively, the new φ(i,j) may be the shorter of a distance from x(i,j), y(i,j) to either an upper portion or an lower portion of the interface 104. The interface 104 may include multiple unconnected interfaces.

FIG. 8E is an illustration of node i,j at which all four neighboring nodes are on the other side of the interface 104. Again the coordinates of the points where the interface crosses the mesh lines at the right, left, lower, and upper sides, i.e. a₂, b₂, a₄, b₄, a₁, b₁, and a₃, b₃, can be easily obtained by linearly interpolating old level set values φ(i,j), φ(i+1,j), φ(i,−1,j), φ(i,j−1), φ(i,j+1). The closest point may be on the line connecting a₁, b₁, and a₂, b₂ or on the line connecting a₃, b₃ and a₄, b₄. Hence we repeat the procedure described above and choose the smaller of the possible new level set values.

FIG. 9 is an additional illustration of the mesh 800 wherein level set values φ(i,j) and the Cartesian coordinates x(i,j), y(i,j) for each level set value φ(i,j) are indicated. Also shown in FIG. 9 are the four nearest neighbors and their Cartesian coordinates.

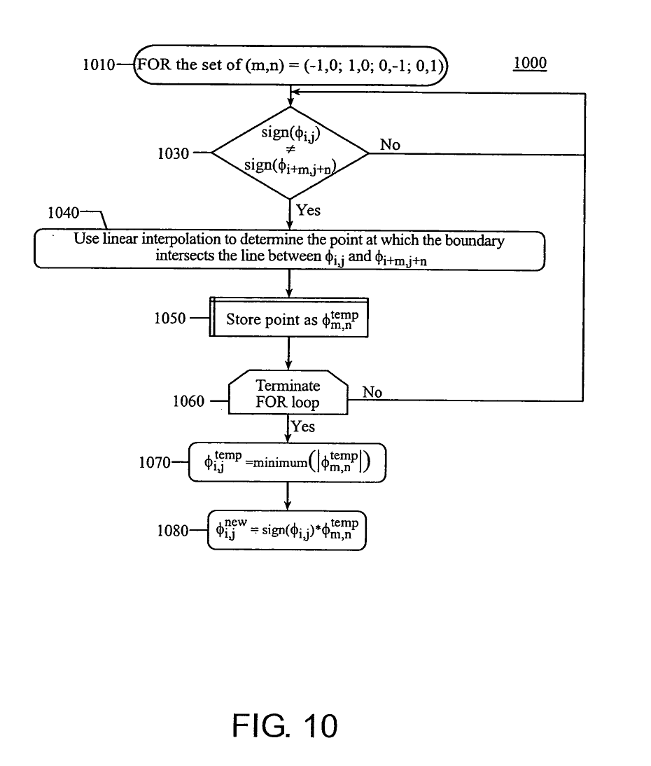

FIG. 10 shows a flowchart 1000 illustrating local linear interpolation as it might be performed within an embodiment of the present invention. Local linear interpolation of a particular level set value φ(i,j) might be performed if the boundary 104 passes between the node i,j and one or more of the node i,j's four nearest neighbors. In a step 1010 a FOR loop may be initialized such that a set of offset indexes m,n={i−1,j; i+1,j; i,j−1; i,j+1} are cycled through in steps 1030 through 1060. In a step 1030 the sign of φ(i,j) is compared to the sign of φ(i+m,j+n). If the signs are equal for a given offset index m,n than steps 1040 and 1050 are skipped and the next offset index is used. If the signs are opposite than during a step 1040 linear interpolation is used to determine a point at which the boundary intersects the line between φ(i,j) and φ(i+m,j+n). This point is stored as φ^{temp}(m,n) in a step 1050. In a step 1060 it is determined if each of the offset indexes have been checked. If not than steps 1030 through 1050 are repeated. After all the offset indexes m,n are cycled through the FOR loop is terminated. In a step 1070 the minimum of the absolute value of the group φ^{temp}(m,n) is temporarily assigned to φ^{temp}(i,j). In a step 1080 the new value of φ^{new}(j,j) is determined to be the sign of the φ(i,j) times φ^{temp}(i,j). Local linear interpolation as described in the flowchart 1000 may be performed for each level set value φ(i,j) or a subset of the level set values which are assumed to be near the interface 104.

An alternative to steps 1070 and 1080 may include approximating the interface 104 with one or more approximate interface segments which intersect one or more pairs of points from the φ^{temp}(m,n) set of points. One or more perpendicular lines may be found which intersect the node (i,j) and are perpendicular to one of the approximate interface segments. The new value for the level set φ^{new}(i,j) may be set to the length of the shortest perpendicular line.

The calculations described above were performed in the physical space X. Alternatively, these calculations may be performed in the computational space Ξ. For the sake of clarity, exception handling was not described in the flowchart 1000. It may be necessary to implement exception handling in order to properly execute the invention. Examples of exceptions that might need to be handled are simulation boundaries and when the interface 104 intersects a node such that a level set value φ is zero. In addition, the method described above is easily extendable to three or more dimensions.

C. Global Interpolation

Global interpolation in the context of the present invention refers to a method for re-distancing a particular node of the level set. When performing global interpolation some approximation of the zero level set Γ is first sought. An example of such approximation may be a series of line segments represented by points along the zero level set Γ. A new level set value for a particular node may be calculated by finding the shortest distance from the particular node to the series of line segments.

1.Finding the Zero Level Set Γ with a Contour Plotting Algorithm

A contour plotting algorithm may be used to find the zero level set Γ of the level set function φ. The zero level set Γ may be of interest for visualization purposes or may be used when re-distancing the level set function φ. An approximation of the level set function may be stored as a two dimensional array of level set values φ(i,j). A goal of the contour plotting algorithm is to find the “zero points” on the mesh lines connecting cell nodes, i.e. the intersections of the zero level set Γ and the mesh lines of the mesh.

The contour plotting algorithm may use two flag arrays lf(i,j) and mf(i,j) to tag the mesh lines that have been checked for intersections with the interface 104. Each element of the array If and mf may be a single bit, while the dimensions of the arrays may be identical to the dimensions of the level set φ(i,j). An element (i,j) of the flag array if may represent a first mesh line connecting a node (i,j) to a node (i,j−1). Similarly an element (i,j) of the array mf may representative of a second mesh line connecting a node (i,j) to a node (i−1,j). The flag arrays may be initialized as all zeroes, indicating that none of the mesh lines have been checked. Once a mesh line has been checked the corresponding element of the relevant flag array may be set to 1. A variable may be used to store the current number of zero points which have been found.

A search for zero points may be done by searching each mesh line from top to bottom. Alternatively the search for zero points may be performed on a domain boundary and then on interior mesh lines. Once a first zero point of the interface 104 is found. The interface 104 may be followed until it ends at the domain boundary or the first zero point. The above steps are repeated until each mesh line has been checked. The zero points may be stored in a 2xn dimensional array z(x.,y.) where m is an index from 1 to n+1.

Following the interface 104 as described above may include checking the neighboring mesh lines to the north, south, east and west of a particular zero point to determine if the interface 104 crosses those mesh lines. Following the interface 104 may also include checking a particular mesh line to determine if the interface 104 crosses the particular mesh line at more than one point. Following the interface 104 may also involve ensuring the interface 104 does not cross itself.

The method described above is just one method for finding the interface 104 using a contour plotting algorithm. Another method for finding the interface 104 may include calculating first and or second order gradients of the level function and using that information to find and follow the interface 104. There are number of methods for finding the interface 104 from the level set φ that are well known in the art.

2. Calculating a New Level Set from the Contour Plot

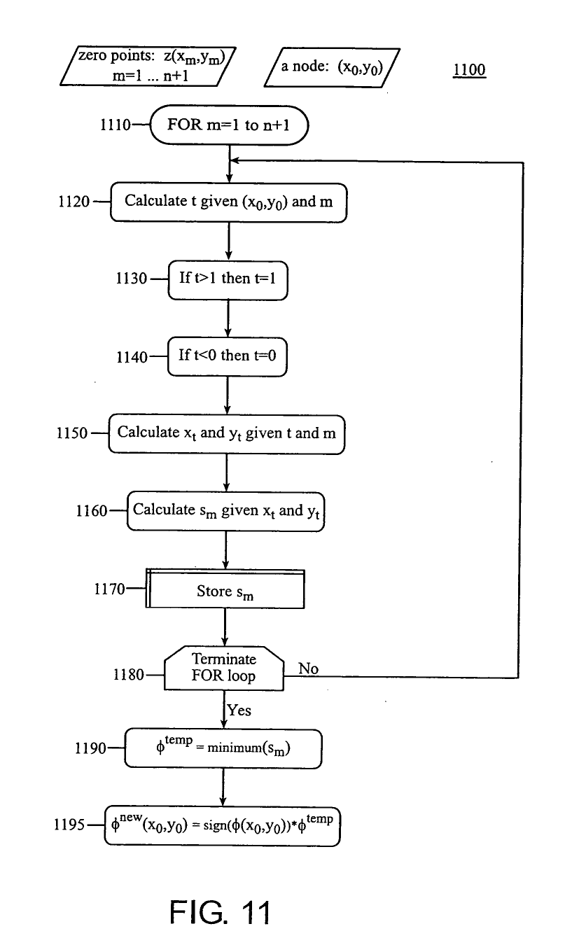

FIG. 11 is a flowchart 1100 illustrating one method for re-distancing specific node (x₀,y₀) of the level set φ, given a set of zero points z(xₘ,yₘ) representative of the interface 104. This method is given for illustration purposes only, other methods for calculating the level set φ at a specific node when a contour of the interface 104 is available are well known in the art. This method may ideally be used for level set values which are within one cell from the interface 104. FIG. 12 is an illustration of a quadrilateral mesh including a portion of the interface 104. FIG. 12 also shows a graphic representation of some of the variables which are referenced in flowchart 1100.

As described above the array z is a list of points which approximate the interface 104. In general the interface 104 may consist of one or more contiguous lines. These contiguous lines may start and end at a boundary of the simulation space. Alternatively one or more of the contiguous line may form an enclosed surface (e.g., a surface might encompass a droplet). The list of points in the array z may be ordered in such a manner that each pair of points which make up a segment of the interface 104 appear next to each other in the array. Duplicate points may be added where necessary. Other values may be added to the array to indicate end points of the interface 104 or other exceptional situations.

A step 1110 may initialize a FOR loop such that an index m is used when checking all the segments along the interface 104. A segment beginning at a point xₘ,yₘ and continuing to a point xₘ₊1,yₘ₊1 is parameterized in accordance with equations (31). In a step 1120 the parameter t is solved for a given node (x₀,y₀) and a given segment m in accordance with equations (31). In a step 1130 t is set to 1 if it is greater than 1. In a step 1140 t is set to 0 if it is less than 0. Steps 1130 and 1140 are performed to limit t to points on segment m. FIG. 12 shows points t for segments m and m+1. In a step 1150 the Cartesian coordinates (xₜ,yₜ) for parameter t along segment m are calculated in accordance with equations (31). In a step 1160 the distance sₘ from the node (x₀,y₀) to (xₜ,yₜ) is calculated in accordance with equations (31). FIG. 12 shows the distances sₘ and sₘ₊1 for segment m and m+1. In a step 1170 the value sₘ is stored for later use. In a step 1180 the FOR loop is terminated or the index m is incremented and steps 1120 to 1170 are repeated. An output of the FOR loop may be an array of distances s. If the FOR loop is terminated then in a step 1190 a temporary level set value is calculated from a minimum of the array of distances s which were stored in the step 1170. In a step 1195 the new level set value at node (x,y) is calculated by multiplying the temporary level set value by the sign of the old level set value at node(x,y). An alternative to step 1195 may be calculating the sign of the new level set value independent of the old level set value. An alternative to the steps 1190 and 1170 may include only storing sₘ if it is smaller than the smallest distance s calculated up to that point.

Thus a new level set value for a particular node is calculated based upon a global evaluation of the interface 104. An alternative embodiment of the invention may include a global evaluation of the interface 104 while the entire interface 104 is not used to calculate the new level set value. Instead only a limited set of interface segments in cells close to the node (x₀,y₀) are used to calculate the new level set value.

For simplicities sake exception handling was not shown in the flowchart 1100. An embodiment of the invention may include exception handling for instances such as boundary conditions and other exceptional situations. Global interpolation has been described in the context of the two-dimensional quadrilateral mesh in the physical space X. With suitable adjustments the method described above may also be performed upon a rectangular gird in the computational space Ξ.

D. Switch Logic

Re-distancing the level set φ may include the use of multiple interpolation methods including: bicubic interpolation; global interpolation; and local linear interpolation. An embodiment of the present invention may use two or three of these methods when re-distancing the level set. In the context of the present invention, choosing which interpolation method to use when re-distancing a particular node of the level set is referred to as switch logic. Motivation for using the switch logic may include: ensuring code stability, reducing artifacts and improving speed.

Bicubic interpolation may be the default interpolation method. The triangulated fast marching method may also be used under certain circumstances. Global interpolation or local linear interpolation may be used for a particular node if the particular node is part of a cell which is next to a domain boundary. Global interpolation or local interpolation may also be used for a particular node if the fluid acceleration at or in the neighborhood of the particular node is higher than a threshold value. In addition, global interpolation or local interpolation may be used for a particular node if the particular node is part of cell which includes an interface 104 with a sharp corner. Furthermore, local interpolation or global interpolation may be used for a particular node if the particular node is part of a cell that includes an interface 104 with a curvature above a certain threshold. In general for most ink jet simulations the interpolation need only be reduced from bicubic for a limited set of nodes. Hence the accuracy of the level set re-distancing is still third-order in the vicinity of the interface.

1. Next to the Domain Boundary

If the interface 104 passes through a cell which is next to the domain boundary then, the bicubic interpolation should not be used. Bicubic interpolation requires sixteen conditions in order to construct the bicubic polynomial upon which bicubic interpolation is based. For cells next to the domain boundary sixteen conditions are not available. Thus bicubic interpolation should not be used. Furthermore, using bicubic interpolation to re-distance the level set at cells next to the boundary has a tendency to push the interface 104 away from the domain boundary. This can result in artifacts being introduced into the simulation. For example, using bicubic interpolation right next to an axis of symmetry often results in the simulation producing a very long droplet which does not pinch off. Such a result is an artifact of the simulation and violates the physics of capillary instability.

2. High Local Fluid Acceleration

The level set projection method described in this application is explicit in time. The time step, Δt, is constrained by Courant-Friedrichs-Lewy (CFL) condition, surface tension, viscosity, and local fluid acceleration. As formulated in equation (32) in which h is the smallest cell dimension (i.e., for axisymmetric coordinates, h=minimum(Δr,Δz)); F is defined in equation 15; Re is the Reynolds number; We is the Weber number; ρ is the relative density; ρ₁ and ρ₂ are the densities of a first and second fluid; μ is the relative dynamic viscosity; u is the radial velocity; and υ is the vertical velocity.

The constraints from the surface tension and the viscosity can be determined at the beginning of a simulation as they only depend on the mesh size and the fluid properties. The CFL and local fluid acceleration should be checked at every time step and for every cell. For implementation purposes, an initial time step size Δt₀ may be calculated based on the surface tension and the viscosity constraints, as stated in equation 33. A Δt' as stated in equation 34 may be calculated at each time step. The smaller of these two constraints may be used as the actual time step size, i.e. Δt=minimum(Δt₀, Δt'). For a given cell if Δt'<Δt₀ then global interpolation or local linear interpolation should be used to re-distance the level set values for that cell.

3. Sharp Corner

When the interface 104 has a sharp corner in or close to a cell, bicubic interpolation should not be used because it has a tendency to smooth sharp corners. Bicubic interpolation works well for portions of the interface 104 which bend continuously in one direction. Bicubic interpolation does not work well where the interface 104 begins to bend in a new direction. For at least this reason it is not sufficient to merely state that bicubic interpolation should not be used if the angle between two segments is less than a particular threshold. A more subtle approach is necessary.

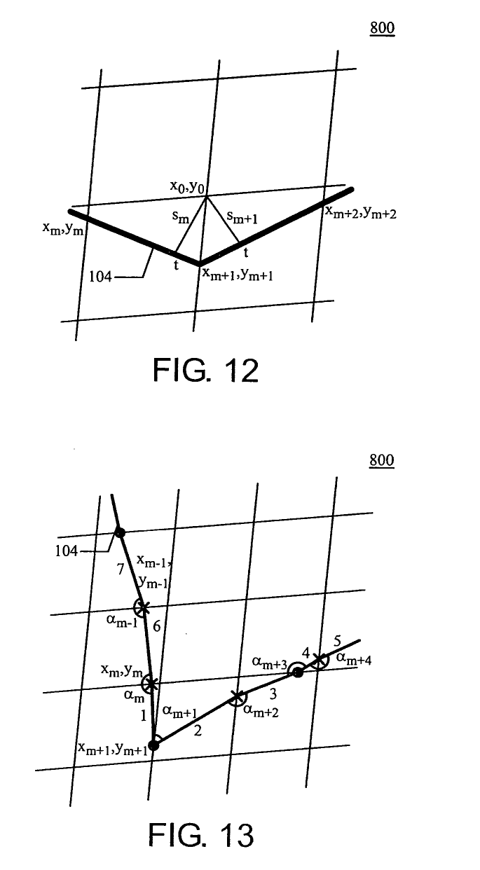

An approximation of the interface 104 used to perform global interpolation may be used to tell whether the interface has a sharp corner or not. FIG. 13 is an illustration of a portion of the interface 104 on the mesh 800. The interface 104 has a sharp corner between segments 1 and 2. Thus, bicubic interpolation should not be used for cells containing segments 1 and 2 but can be used for cells containing segments 3, 4, 5, 6 and 7.

Suppose we are considering the mth segment of the interface 104 with end points xₘ,yₘ and xₘ₊₁,yₘ₊₁ as shown in FIG. 13 wherein segment 1 is the mth segment. Each segment may be represented by a vector (Δxₘ,Δyₘ) as shown in equation 35. The angles αₘ and αₘ₊₁ made by the mth segment, the previous segment and the next segment should be calculated. This can be done using the cosine theorem as shown in equation 36. FIG. 13 illustrates several such angles (αₘ₋₁ . . . αₘ₊₄) that could be calculated in such a manner. As shown in FIG. 13 angle αₘ is the interior angle of a triangle formed by the mth segment the previous segment and a line connecting these two segments. Other methods for calculating or approximating the angle formed by two lines are well known in the art.

Another piece of information that may be used to determine if the cell includes a sharp corner is the relative direction in which the segments are bending. This information may be found by calculating the cross product of the previous segment with the mth segment, dirₘ=(Δxₘ₋₁,Δyₘ₋₁)×(Δxₘ,Δyₘ). The only information used from this calculation is the sign of dirₘ. The results of this cross product are segments m−1 through m+4 are shown in FIG. 13. Vectors pointing out of the page are represented by dots while vectors pointing into the page are represented by crosses.

Bicubic interpolation should not be used and global interpolation or local linear interpolation should be used instead if the cell containing segment m meets one of the following two conditions:
dirₘ·dirₘ₊₁≦0 and 0<αₘ≦40° and 0<αₘ₊₁≦40°; or
dirₘ·dirₘ₊₁<0 and(0<αₘ≦75° or 0<αₘ₊₁≦75°).

For the first condition, a first upper limit may be 40° although other angles such as 30°, 50° or 60° may be used without going outside the scope of the invention. For the second condition, a second upper limit may be 75° although other angles such as 60° or 80° may be used without going outside the scope of the invention. In an embodiment of the invention the first upper limit may be less than the second upper limit.

4. Curvature of the Interface

When the interface 104 has a sharp corner in or close to a particular cell, the curvature κ of the level set φ evaluated at nodes of the particular cell will tend to be high. On quadrilateral meshes, the curvature can be calculated by equation 37. All of the derivatives in the above formula can be numerically calculated in the computational space by use of the central difference formula. Other methods for calculating the derivative are well known in the art.

The curvature of a cell may be considered high if the curvature of any of the nodes in that cell is greater than a threshold. The threshold may be inversely proportional to the parameter ε which as noted above representative of the extent to which the interface 104 is smeared. If the curvature is greater than the threshold then bicubic interpolation should not be used and global or local linear interpolation should be used.

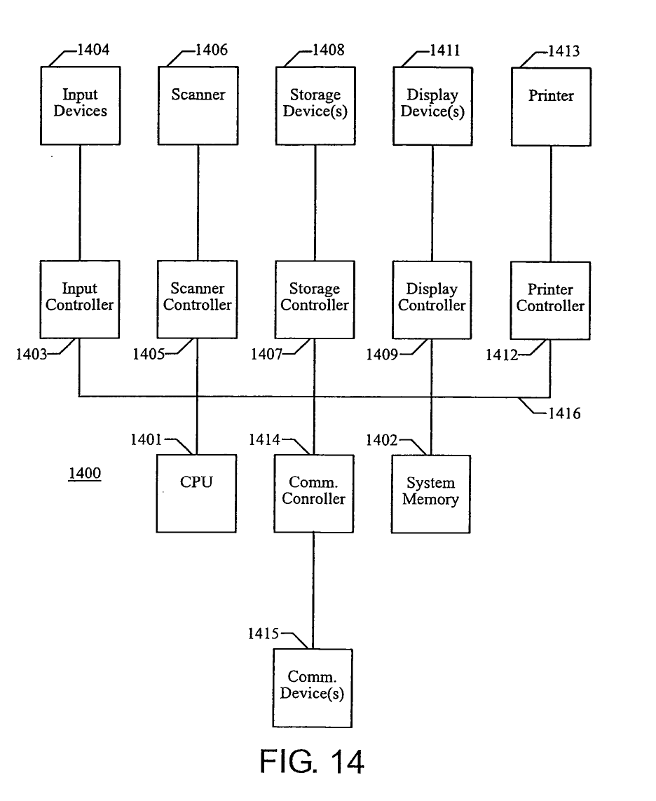

Having described the details of the invention, an exemplary system 1400 which may be used to implement one or more aspects of the present invention will now be described with reference to FIG. 14. As illustrated in FIG. 14, the system includes a central processing unit (CPU) 1401 that provides computing resources and controls the computer. The CPU 1401 may be implemented with a microprocessor or the like, and may also include a graphics processor and/or a floating point coprocessor for mathematical computations. The system 1400 may also include system memory 1402 which may be in the form of random-access memory (RAM) and read-only memory (ROM).

A number of controllers and peripheral devices may also be provided, as shown in FIG. 14. An input controller 1403 represents an interface to various input device(s) 1404, such as a keyboard, mouse or stylus. There may also be a scanner controller 1405 which communicates with a scanner 1406. The system 1400 may also include a storage controller 1407 for interfacing with one or more storage devices 1408 each of which includes a storage medium such as magnetic tape or disk, or an optical medium that might be used to record programs of instructions for operating systems, utilities and applications which may include embodiments of programs that implement various aspects of the present invention. Storage device(s) 1408 may also be used to store processed data or data to be processed in accordance with the invention. The system 1400 may also include a display controller 1409 for providing an interface to a display device 1411 which may be a cathode ray tube (CRT) or a thin film transistor (TFT) display. The system 1400 may also include a printer controller 1412 for communicating with a printer 1413. A communications controller 1414 may interface with one or more communication devices 1415 which enables the system 1400 to connect to remote devices through any of a variety of networks including the Internet, a local area network (LAN), a wide area network (WAN), or through any suitable electromagnetic carrier signals including infrared signals.

In the illustrated system, all major system components may connect to a bus 1416 which may represent more than one physical bus. However, various system components may or may not be in physical proximity to one another. For example, input data and/or output data may be remotely transmitted from one physical location to another. Also, programs that implement various aspects of this invention may be accessed from a remote location (e.g., a server) over a network. Such data and/or programs may be conveyed through any of a variety of computer-readable medium including magnetic tape or disk or optical disc, network signals, or any other suitable electromagnetic carrier signals including infrared signals.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. Accordingly, the “means” terms in the claims are intended to cover both software and hardware implementations. Similarly, the term “computer-readable medium” as used herein includes software, hardware having a program of instructions hardwired thereon, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software) which may be stored on, or conveyed to, a computer or other processor-controlled device for execution. Alternatively, any of the methods or steps thereof may be implemented using functionally equivalent hardware (e.g., application specific integrated circuit (ASIC), digital signal processing circuitry, etc.) or a combination of software and hardware.

While the invention has been described in conjunction with several specific embodiments, further alternatives, modifications, variations and applications will be apparent to those skilled in the art in light of the foregoing description. Examples of such alternatives, among others include: higher dimensions; alternate coordinate systems; alternate fluids; alternate boundary conditions; alternate channels; alternate governing equations; and systems with more than two fluids. Thus, the invention described herein is intended to embrace all such alternatives, modifications, variations and applications as may fall within the spirit and scope of the appended claims.

$$\begin{matrix}∇ \cdot u = 0 , \\ \begin{matrix}\frac{Du}{ Dt} = - \frac{1}{ ρ ( ϕ )} ∇ p + \frac{1}{ ρ ( ϕ ) Re} ∇ \cdot ( 2 μ ( ϕ ) D ) - \\ \frac{1}{ ρ ( ϕ ) We} κ ( ϕ ) δ ( ϕ ) ∇ ϕ - \frac{1}{ Fr} {e}_{ z} ,\end{matrix} \\ \frac{\partial ϕ}{\partial t} + u \cdot ∇ ϕ = 0. & ( 1 ) \\ J = g det {∇}_{Ξ} Φ = g det ( \begin{matrix}{r}_{ξ} & {r}_{η} \\ {z}_{ξ} & {z}_{η}\end{matrix} ) . & ( 2 ) \\ T = {g}^{- 1} {J [ {∇}_{Ξ} Φ ]}^{- 1} = ( \begin{matrix}{z}_{η} & - {r}_{η} \\ - {z}_{ξ} & {r}_{ξ}\end{matrix} ) . & ( 3 ) \\ {∇}_{Ξ} \cdot \overline{u} = 0 , \overline{u} = g Tu , \\ \begin{matrix}\frac{\partial u}{\partial t} + {J}^{- 1} ( \overline{u} \cdot {∇}_{Ξ} ) u = \frac{1}{ρ ( ϕ ) J} {gT}^{T} {∇}_{Ξ} p + ( Viscosity term ) - \frac{1}{ Fr} {e}_{ z} - \\ \frac{g δ ( ϕ )}{{J}^{2} ρ ( ϕ ) We} {∇}_{Ξ} \cdot ( g T \frac{ {T}^{ T} {∇}_{Ξ} ( ϕ )}{\vert {T}^{ T} {∇}_{Ξ} ( ϕ ) \vert} ) ( {T}^{ T} {∇}_{Ξ} ϕ ) ,\end{matrix} \\ \frac{\partial ϕ}{\partial t} + {J}^{- 1} \overline{u} \cdot {∇}_{Ξ} ϕ = 0. & ( 4 ) \\ \begin{matrix}( Viscosity term ) = = \frac{g}{J ρ ( ϕ ) Re} [ {T}^{T} {∇}_{Ξ} μ ( ϕ ) ] \cdot \\ [ g {J}^{- 1} {T}^{T} {∇}_{Ξ} u + {( g {J}^{- 1} {T}^{T} {∇}_{Ξ} u )}^{T} ] + \\ \frac{μ ( ϕ )}{J ρ ( ϕ ) Re} {∇}_{Ξ} \cdot \{ {g}^{2} {J}^{- 1} T {T}^{T} {∇}_{Ξ} u \} + \frac{μ ( ϕ )}{ ρ ( ϕ ) Re} ( \begin{matrix}- \frac{u}{{r}^{ 2}} \\ 0\end{matrix} ) .\end{matrix} & ( 5 ) \\ H ( ϕ ) = \{ \frac{\begin{matrix}0 \\ 1\end{matrix}}{\begin{matrix}2 \\ 1\end{matrix}} [ 1 + \frac{ϕ}{ε} + \frac{1}{π} sin ( πϕ / ε ) ] \begin{matrix}if & ϕ < - ε \\ if & \vert ϕ \vert \leq ε \\ if & ϕ > ε\end{matrix} , δ ( ϕ ) = \frac{ⅆ H ( ϕ )}{ⅆ ϕ} . & ( 6 ) \\ ρ ( ϕ ) = \frac{{ρ}_{2}}{{ρ}_{1}} + ( 1 - \frac{{ρ}_{2}}{{ρ}_{1}} ) H ( ϕ ) . & ( 7 ) \\ {ϕ}^{n + 1} = {ϕ}^{n} - {\frac{Δ t}{J} [ \overline{u} \cdot {∇}_{Ξ} ϕ ]}^{n + 1 / 2} . & ( 8 ) \\ \begin{matrix}{u}^{*} = {u}^{n} + Δ t \{ - {{J}^{- 1} [ ( \overline{u} \cdot {∇}_{Ξ} ) u ]}^{n + 1 / 2} + {( Viscosity term )}^{n} + \\ {( Surface tension )}^{n + 1 / 2} - \frac{1}{Fr} {e}_{2} \} .\end{matrix} & ( 9 ) \\ {∇}_{Ξ} \cdot ( {gTu}^{*} ) = {∇}_{Ξ} \cdot ( \frac{{g}^{2} Δ t}{ρ ( {ϕ}^{n + 1 / 2} ) J} T {T}^{T} {∇}_{Ξ} {p}^{n + 1} ) . & ( 10 ) \\ {u}^{n + 1} = {u}^{*} - \frac{g Δ t}{ρ ( {ϕ}^{n + 1 / 2} ) J} {T}^{T} {∇}_{Ξ} {p}^{n + 1} . & ( 11 ) \\ \begin{matrix}{[ ( \overline{u} \cdot {∇}_{Ξ} ) u ]}_{i , j}^{n + 1 / 2} = \frac{{\overline{u}}_{i + 1 / 2 , j}^{n + 1 / 2} + {\overline{u}}_{i - 1 / 2 , j}^{n + 1 / 2}}{2} ( {u}_{i + 1 / 2 , j}^{n + 1 / 2} - {u}_{i - 1 / 2 , j}^{n + 1 / 2} ) + \\ \frac{{\overline{v}}_{i , j + 1 / 2}^{n + 1 / 2} + {\overline{v}}_{i , j - 1 / 2}^{n + 1 / 2}}{2} ( {u}_{i , j + 1 / 2}^{n + 1 / 2} - {u}_{i , j - 1 / 2}^{n + 1 / 2} ) .\end{matrix} & ( 12 ) \\ \begin{matrix}{[ ( \overline{u} \cdot {∇}_{Ξ} ) ϕ ]}_{i , j}^{n + 1 / 2} = \frac{{\overline{u}}_{i + 1 / 2 , j}^{n + 1 / 2} + {\overline{u}}_{i - 1 / 2 , j}^{n + 1 / 2}}{2} ( {ϕ}_{i + 1 / 2 , j}^{n + 1 / 2} - {ϕ}_{i - 1 / 2 , j}^{n + 1 / 2} ) + \\ \frac{{\overline{v}}_{i , j + 1 / 2}^{n + 1 / 2} + {\overline{v}}_{i , j - 1 / 2}^{n + 1 / 2}}{2} ( {ϕ}_{i , j + 1 / 2}^{n + 1 / 2} - {ϕ}_{i , j + 1 / 2}^{n + 1 / 2} ) .\end{matrix} & ( 13 ) \\ \begin{matrix}{u}_{i + 1 / 2 , j}^{n + 1 / 2 , L} = {u}_{i , j}^{n} + \frac{1}{2} {u}_{ξ , i , j}^{n} + \frac{Δ t}{2} {u}_{t , i , j}^{n} \\ = {u}_{i , j}^{n} + ( \frac{1}{2} - \frac{Δ t}{2 {J}_{i , j}} {\overline{u}}_{i , j}^{n} ) {u}_{ξ , i , j}^{n} - \frac{Δ t}{2 {J}_{i , j}} {( \overline{v} {u}_{η} )}_{i , j}^{n} + \frac{Δ t}{2} {F}_{i , j}^{n} .\end{matrix} & ( 14 ) \\ \begin{matrix}{F}_{i , j}^{n} = \{ - \frac{g}{ρ ( ϕ ) J} {∇}_{Ξ} p + ( Viscosity term ) + \\ { ( Surface tension ) - \frac{1}{Fr} {e}_{2} \}}_{i , j}^{n} .\end{matrix} & ( 15 ) \\ \begin{matrix}{u}_{i + 1 / 2 , j}^{n + 1 / 2 , R} = {u}_{i + 1 , j}^{n} - \frac{1}{2} {u}_{ξ , i + 1 , j}^{n} + \frac{Δ t}{2} {u}_{t , i + 1 , j}^{n} \\ = {u}_{i + 1 , j}^{n} - ( \frac{1}{2} + \frac{Δ t}{2 {J}_{i + 1 , j}} {\overline{u}}_{i + 1 , j}^{n} ) {u}_{ξ , i + 1 , j}^{n} - \\ \frac{Δ t}{2 {J}_{i + 1 , j}} {( \overline{v} {u}_{η} )}_{i + 1 , j}^{n} + \frac{Δ t}{2} {F}_{i + 1 , j}^{n} .\end{matrix} & ( 16 ) \\ {\overline{u}}_{i + 1 / 2 , j}^{n + 1 / 2} = \{ \begin{matrix}{\begin{matrix}\overline{u}\end{matrix}}_{i + 1 / 2 , j}^{n + 1 / 2 , L} if {\overline{u}}_{i + 1 / 2 , j}^{n + 1 / 2 , L} > 0 and {{u}^{ \_}}_{ i + 1 / 2 , j}^{ n + 1 / 2 , L} + {\overline{u}}_{i + 1 / 2 , j}^{n + 1 / 2 , R} > 0 \\ {\begin{matrix}\overline{u}\end{matrix}}_{i + 1 / 2 , j}^{n + 1 / 2 , R} if {\overline{u}}_{i + 1 / 2 , j}^{n + 1 / 2 , R} < 0 and {\overline{u}}_{i + 1 / 2 , j}^{n + 1 / 2 , L} + {\overline{u}}_{i + 1 / 2 , j}^{n + 1 / 2 , R} < 0 \\ 0 otherwise\end{matrix} . & ( 17 ) \\ {u}_{i + 1 / 2 , j}^{n + 1 / 2} ( or {ϕ}_{i + 1 / 2 , j}^{n + 1 / 2} ) = \{ \begin{matrix}{u}_{i + 1 / 2 , j}^{n + 1 / 2 , L} ( or {ϕ}_{i + 1 / 2 , j}^{n + 1 / 2 , L} ) & & if {\overline{u}}_{i + 1 / 2 , j}^{n + 1 / 2} > 0 \\ {u}_{i + 1 / 2 , j}^{n + 1 / 2 , R} ( or {ϕ}_{i + 1 / 2 , j}^{n + 1 / 2 , R} ) & & if {\overline{u}}_{i + 1 / 2 , j}^{n + 1 / 2} < 0 \\ \frac{{u}_{i + 1 / 2 , j}^{n + 1 / 2 , L} + {u}_{i + 1 / 2 , j}^{n + 1 / 2 , R}}{2} & ( or \frac{\begin{matrix}{ϕ}_{i + 1 / 2 , j}^{n + 1 / 2 , L} + \\ {ϕ}_{i + 1 / 2 , j}^{n + 1 / 2 , R}\end{matrix}}{2} ) & if {\overline{u}}_{i + 1 / 2 , j}^{n + 1 / 2} = 0\end{matrix} . & ( 18 ) \\ {ϕ}_{i , j - 1} + \frac{s}{ Δ y } ( {ϕ}_{i , j} - {ϕ}_{i , j - 1} ) = 0 , \\ Δ y = \sqrt{{( {x}_{i , j} - {x}_{i , j - 1} )}^{2} + {( {y}_{i , j} - {y}_{i , j - 1} )}^{2}} . & ( 19 ) \\ s = \frac{{ϕ}_{i , j - 1}}{{ϕ}_{i , j - 1} - {ϕ}_{i , j}} Δ y . & ( 20 ) \\ {( {ϕ}_{i , j} )}_{new} = sign {( {ϕ}_{i , j} )}_{old} \times s . & ( 21 ) \\ ( {a}_{1} + t Δ a , {b}_{1} + t Δ b ) , ( Δ a , Δ b ) = ( {a}_{2} - {a}_{1} , {b}_{2} - {b}_{1} ) . & ( 22 ) \\ ( {( x , y )}_{i , j} - ( {a}_{1} + t Δ a , {b}_{1} + t Δ b ) ) \cdot ( Δ a , Δ b ) = 0. & ( 23 ) \\ t = \frac{Δ a ( {x}_{i , j} - {a}_{1} ) + Δ b ( {y}_{i , j} - {b}_{1} )}{Δ {a}^{2} + Δ {b}^{2}} . & ( 24 ) \\ {( {ϕ}_{i , j} )}_{new} = {sign ( {ϕ}_{i , j} )}_{old} \sqrt{{( {x}_{i , j} - {a}_{1} - t Δ a )}^{2} + {( {y}_{i , j} - {b}_{1} - t Δ b )}^{2} .} & ( 25 ) \\ {t}_{1} = \frac{( {a}_{2} - {a}_{1} ) ( {x}_{i , j} - {a}_{1} ) + ( {b}_{2} - {b}_{1} ) ( {y}_{i , j} - {b}_{1} )}{{( {a}_{2} - {a}_{1} )}^{2} + {( {b}_{2} - {b}_{1} )}^{2}} . & ( 26 ) \\ \vert {ϕ}_{i , j}^{1} \vert = \sqrt{{[ {x}_{i , j} - {a}_{1} - {t }_{1} ( {a}_{2} - {a}_{1} ) ]}^{2} + {[ {y}_{i , j} - {b}_{1} - t ( {b}_{2} - {b}_{1} ) ]}^{2}} . & ( 27 ) \\ {t}_{2} = \frac{( {a}_{2} - {a}_{3} ) ( {x}_{i , j} - {a}_{3} ) + ( {b}_{2} - {b}_{3} ) ( {y}_{i , j} - {b}_{3} )}{{( {a}_{2} - {a}_{3} )}^{2} + {( {b}_{2} - {b}_{3} )}^{2}} & ( 28 ) \\ \vert {ϕ}_{i , j}^{2} \vert = \sqrt{{[ {x}_{i , j} - {a}_{3} - {t }_{2} ( {a}_{2} - {a}_{3} ) ]}^{2} + {[ {y}_{i , j} - {b}_{3} - t ( {b}_{2} - {b}_{3} ) ]}^{2}} . & ( 29 ) \\ {( {ϕ}_{i , j} )}_{new} = {sign ( {ϕ}_{i , j} )}_{old} min ( \vert {ϕ}_{i , j}^{1} \vert , \vert {ϕ}_{i , j}^{2} \vert ) . & ( 30 ) \\ {x}_{ t} = {x}_{m} + t ( {x}_{m + 1} + {x}_{m} ) {y}_{t} = {y}_{m} + t ( {y}_{m + 1} - {y}_{m} ) , \\ t = \frac{( {x}_{ m + 1} - {x}_{ m} ) ( {x}_{ 0} - {x}_{ m} ) + ( {y}_{ m + 1} - {y}_{ m} ) ( {y}_{ 0} - {y}_{ m} )}{{( {x}_{m + 1} - {x}_{m} )}^{2} + {( {y}_{m + 1} - {y}_{m} )}^{2}} , \\ {s}_{m} = \sqrt{{( {x}_{0} - {x}_{t} )}^{2 } + {( {y}_{0} - {y}_{t} )}^{2}} . & ( 31 ) \\ Δ t < {min}_{i , j} [ \frac{Δ r}{u} , \frac{Δ z}{v} , \sqrt{We \frac{{ρ}_{1} + {ρ}_{2}}{8 π}} {h}^{3 / 2} , \frac{Re}{2} \frac{{ρ}^{n}}{{μ}^{n}} {( \frac{1}{Δ {r}^{2}} + \frac{1}{Δ {z}^{2}} )}^{- 1} , \sqrt{\frac{2 h}{\vert F \vert}} ] . & ( 32 ) \\ Δ {t}_{0} < {min}_{i , j} [ \sqrt{We \frac{{ρ}_{1} + {ρ}_{2}}{8 π}} {h}^{3 / 2} , \frac{Re}{2} \frac{{ρ}^{n}}{{μ}^{n}} {( \frac{1}{Δ {r}^{2}} + \frac{1}{Δ {z}^{2}} )}^{- 1} ] . & ( 33 ) \\ Δ {t}^{′} < {min}_{i , j} [ \frac{Δr}{u} , \frac{Δz}{υ} , \sqrt{\frac{2 h}{\vert F \vert}} ] . & ( 34 ) \\ ( Δ {x}_{m} , Δ {y}_{m} ) = ( {x}_{m + 1} , {y}_{m + 1} ) - ( {x}_{m} , {y}_{m} ) . & ( 35 ) \\ \begin{matrix}{α}_{m} = arccos \frac{( Δ {x}_{m - 1} Δ {x}_{m} + Δ {y}_{m - 1} Δ {y}_{m} )}{\sqrt{Δ {x}_{m - 1}^{2} + Δ {y}_{m - 1}^{2}} \sqrt{Δ {x}_{m}^{2} + Δ {y}_{m}^{2}}} , \\ {α}_{m + 1} = arccos \frac{( Δ {x}_{m + 1} Δ {x}_{m} + Δ {y}_{m + 1} Δ {y}_{m} )}{\sqrt{Δ {x}_{m + 1}^{2} + Δ {y}_{m + 1}^{2}} \sqrt{Δ {x}_{m}^{2} + Δ {y}_{m}^{2}}} .\end{matrix} & ( 36 ) \\ κ ( ϕ ) = {J}^{- 1} {∇}_{Ξ} \cdot ( g T \frac{{T}^{T} {∇}_{Ξ} ϕ}{\vert {T}^{T} {∇}_{Ξ} ϕ \vert} ) . & ( 37 )\end{matrix}$$

What is claimed is:

1. A method for simulating fluid flow through a channel and exiting the channel, the fluid flow including an interface between a first fluid and a second fluid, comprising the steps of:
creating a mesh representative of a physical space of the channel and a portion of a physical space around the channel;
creating a level set including a group of values, each value associated with a point in the mesh, each value in the group of values is proportional to the shortest distance from the associated point to the interface;
solving a set of equations which describe aspects of the first fluid, the second fluid and the interface;
re-distancing particular values in the level set using two or more of the following re-distancing methods: a bicubic interpolation method; a global interpolation method; or a local linear interpolation method; and
switching between the bicubic interpolation method and either the global interpolation method or the local linear interpolation method for each particular value based upon one or more switching rules.

2. The method of claim 1, wherein the first fluid is ink, the second fluid is air, and the channel comprises an ink-jet nozzle that is part of an ink jet head.

3. The method of claim 1, wherein the mesh is a quadrilateral mesh and further comprising the steps of:
transforming the mesh into a uniform square mesh in a computational space;
transforming the set of equations from the physical space to the computational space; and
solving the set of equations in the computational space.

4. The method of claim 1, wherein solving the set of equations includes using a finite difference method.

5. The method of claim 1, wherein the switching rules include switching to either the global interpolation method or the local interpolation method for a particular point if the particular point is part of a cell that includes the interface and a portion of the interface of the cell has a sharp corner.

6. The method of claim 5, wherein a particular corner of the interface is sharp if an angle, between two consecutive segments connected at the particular corner is less than forty-five degrees.

7. The method of claim 5, wherein a particular corner of the interface is sharp if three consecutive segments bend towards each other and the two angles between the three segments are both less than or equal to 40°.

8. The method of claim 5, wherein a particular corner of the interface is sharp if three consecutive segments bend away from each other and one of the two angles between the three segments is less than or equal to 75°.

9. The method of claim 5, wherein a particular corner of the interface is sharp if the curvature of the level set of a group consisting of four nodes of a cell that includes the corner or is close to the corner is greater than a critical curvature value.

10. The method of claim 9, wherein the critical curvature value is inversely proportional to the extent of interface smearing.

11. The method of claim 1, wherein the switching rules includes switching to the general interpolation method for a particular point if the particular point is part of a cell next to a domain boundary.

12. The method of claim 1, wherein the switching rules include switching to the general interpolation method for a particular point if local fluid acceleration at the particular point is higher than a threshold.

13. The method of claim 1, wherein a point is co-located with a node on the mesh.

14. The method of claim 1, further comprising the step of solving the set of equations to describe the ejection of a portion of the first fluid from the channel.

15. The method of claim 1, wherein a particular value in the level set has a first sign if the fluid at the point associated with the particular value is the first fluid and has the opposite sign if the fluid at the associated point is the second fluid.

16. The method of claim 1, wherein the fluid flow is simulated in a 3-dimensional coordinate system.

17. The method of claim 16, wherein the coordinate system is an axially symmetric coordinate system, and the fluid flow along the azimuth is not simulated.

18. The method of claim 1, further comprising the step of re-distancing the level set at points more than one cell from the interface using the triangulated fast marching method.

19. An apparatus that includes a module for performing the method of claim 1.

20. A computer-readable medium including a set of instructions for directing an apparatus to perform the method of claim 1.
